(19) United States
(12) Patent Application Publication
(10) Pub. No.: US 2023/0420166 A1
(43) Pub. Date: Dec. 28, 2023

(54) RARE EARTH SINTERED MAGNET, METHOD OF MANUFACTURING RARE EARTH SINTERED MAGNET, ROTOR, AND ROTATING MACHINE

(71) Applicant: Mitsubishi Electric Corporation, Tokyo (JP)

(72) Inventors: Akito IWASAKI, Tokyo (JP); Yoshikazu NAKANO, Tokyo (JP); Yasutaka NAKAMURA, Tokyo (JP); Yukina YOSHIOKA, Tokyo (JP)

(73) Assignee: Mitsubishi Electric Corporation, Tokyo (JP)

(21) Appl. No.: 18/033,800

(22) PCT Filed: Nov. 17, 2020
(86) PCT No.: PCT/JP2020/042845

§ 371 Date: Apr. 26, 2023

(51) Int. Cl. H01F 1/057; C22C 38/00; B22F 3/16; B22F 9/04; B22F 3/24

(52) U.S. Cl. CPC H01F 1/0577; C22C 38/002; C22C 38/005; B22F 3/16; B22F 9/04; B22F 3/24; B22F 2999/00; B22F 2998/10; B22F 2301/355; B22F 2003/248

(57) ABSTRACT

A rare earth sintered magnet has a main phase and a grain boundary phase, the main phase has an R₂Fe₁₄B crystal structure, rare earth elements R include at least Nd and Sm, and the content of Sm is higher in the main phase than in the grain boundary phase. The rare earth elements R may include La. In this manner, the higher content of Sm in the main phase than in the grain boundary phase suppresses the heat generation of the rare earth sintered magnet due to eddy current loss.

### TECHNICAL FIELD

This invention relates to a rare earth sintered magnet, which is a permanent magnet made of sintered materials containing rare earth elements, a method of manufacturing the rare earth sintered magnet, a rotor, and a rotating machine.

### BACKGROUND TECHNOLOGY

R-T-B system rare earth sintered magnets are magnets whose main constituent elements are a rare earth element R, a transition metal element T such as Fe (iron) or Fe partially substituted with Co (cobalt), and B (boron). In particular, an Nd—Fe—B system sintered magnet, in which the rare earth element R is Nd (neodymium), is applied to various components because of its excellent magnetic properties. When the R—Fe—B system sintered magnet is applied to industrial motors and the like, its operating ambient temperature exceeds 100 deg C. Therefore, a heavy rare earth element such as Dy (dysprosium) is added to the conventional R-T-B system rare earth sintered magnet for high heat resistance. The addition of Dy, which has a higher electrical resistivity than Nd, suppresses an eddy current loss generated in the magnet. This suppresses heat generation due to the eddy current loss to prevent the magnet to become too hot. On the other hand, there are concerns about the supply of Nd and Dy because their resources are unevenly distributed and their production is limited. To reduce the amounts of Nd and Dy used in the conventional rare earth sintered magnet, rare earth elements R other than Nd and Dy, such as Ce (cerium), La (lanthanum), Sm (samarium), Sc (scandium), Gd (gadolinium), Y (yttrium), and Lu (lutetium), are used. For example, Patent Document 1 discloses a permanent magnet in which the amounts of Nd and Dy used are reduced by containing La and Sm as the rare earth elements R.

### CITATION LIST

### Patent Document

Patent Document 1

WO 2019/111328

### SUMMARY OF INVENTION

### Technical Problem

Patent Document 1 describes a permanent magnet containing Sm, which has a higher electrical resistivity than Nd, but does not describe Sm in the magnet internal structure and suppression of eddy current loss. In the permanent magnet of Patent Document 1, La and Sm added to Nd₂Fe₁₄B are likely to be uniformly dispersed in the permanent magnet. However, to suppress the eddy current loss, the Sm content in the main phase, where eddy currents are generated, must be controlled to be higher. Thus, simply including elements with high electrical resistivity is not enough to suppress the heating of the magnet due to the eddy current loss.

The present disclosure is made to solve the aforementioned problems and to provide a rare earth sintered magnet that suppresses heat generation due to the eddy current loss, a method of manufacturing the rare earth sintered magnet, a rotor including the rare earth sintered magnet, and a rotating machine including the rare earth sintered magnet.

### Solution to Problem

The rare earth sintered magnet according to the present disclosure is a rare earth sintered magnet having a main phase and a grain boundary phase, wherein the main phase has an R₂Fe₁₄B crystal structure and rare earth elements R include at least Nd and Sm, and the content of Sm is higher in the main phase than in the grain boundary phase.

### Advantageous Effects of Invention

According to the present disclosure, the higher content of Sm in the main phase than in the grain boundary phase suppresses heat generation in the rare earth sintered magnet due to the eddy current loss.

### BRIEF DESCRIPTION OF DRAWINGS

FIG. 1 is a schematic diagram of a part of a rare earth sintered magnet according to Embodiment 1.

FIG. 2 is a schematic diagram of a part of the rare earth sintered magnet according to Embodiment 1.

FIG. 3 is a schematic diagram of a part of the rare earth sintered magnet according to Embodiment 1.

FIG. 4 is a schematic diagram of a part of the rare earth sintered magnet according to Embodiment 1.

FIG. 5 is a diagram showing atomic sites in a tetragonal Nd₂Fe₁₄B crystal structure.

FIG. 6 is a flowchart showing a procedure of a method of manufacturing a rare earth sintered magnet according to Embodiment 2.

FIG. 7 is a schematic diagram showing an operation of a raw alloy production process according to Embodiment 2.

FIG. 8 is a schematic cross-sectional view of a rotor according to Embodiment 3.

FIG. 9 is a schematic cross-sectional view of a rotating machine according to Embodiment 4.

### DESCRIPTION OF EMBODIMENTS

### Embodiment 1

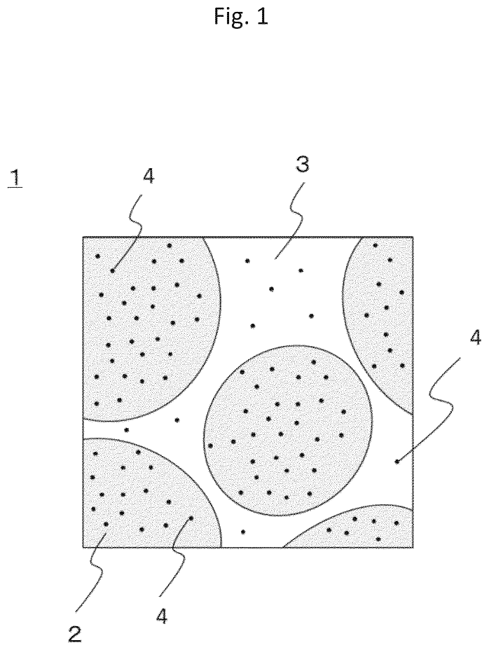

A rare earth sintered magnet 1 according to Embodiment 1 is described with reference to FIG. 1. FIG. 1 is a schematic diagram of a part of the rare earth sintered magnet 1, schematically showing positions of Sm elements 4 by black dots. The rare earth sintered magnet 1 includes a plurality of regions of a main phase 2 each having an R₂Fe₁₄B crystal structure containing at least Nd and Sm as rare earth elements R, and a grain boundary phase 3 formed among the plurality of regions of the main phase 2. The content of Sm is higher in the main phase 2 than in the grain boundary phase 3. Here, “the content of Sm is higher in the main phase 2 than in the grain boundary phase 3” means that the detection intensity of Sm is higher on average in the main phase 2 than in the grain boundary phase 3 in mapping analysis using an electron probe micro analyzer (EPMA).

The main phase 2 has the R₂Fe₁₄B crystal structure containing at least Nd and Sm as the rare earth elements R. That is, the main phase 2 has an (Nd, Sm)₂Fe₁₄B crystal structure formed by Sm substitution at some of Nd sites of an Nd₂Fe₁₄B crystal structure. Further, La is preferably contained as a rare earth element R. When La is contained, the crystal structure is (Nd, La, Sm)₂Fe₁₄B which is formed by substitution made by La and Sm at some of the Nd sites of the Nd₂Fe₁₄B crystal structure. The average size of crystal grains of the main phase 2 is, for example, less than 100 μm, preferably between 0.1 μm and 50 μm, to improve magnetic properties.

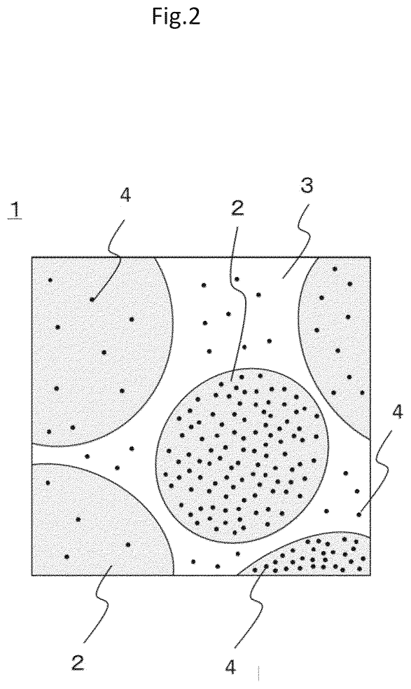

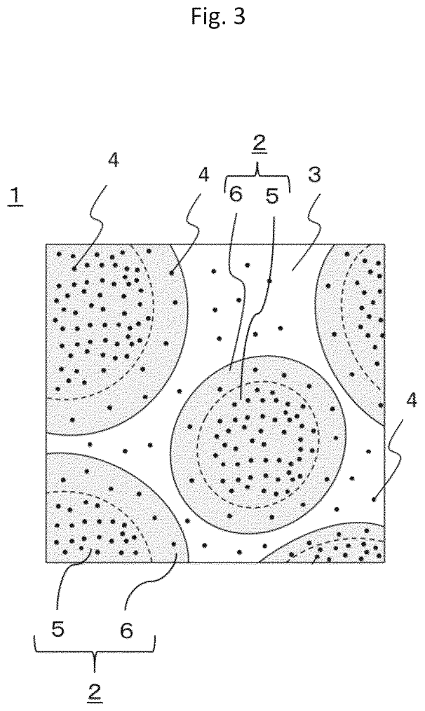

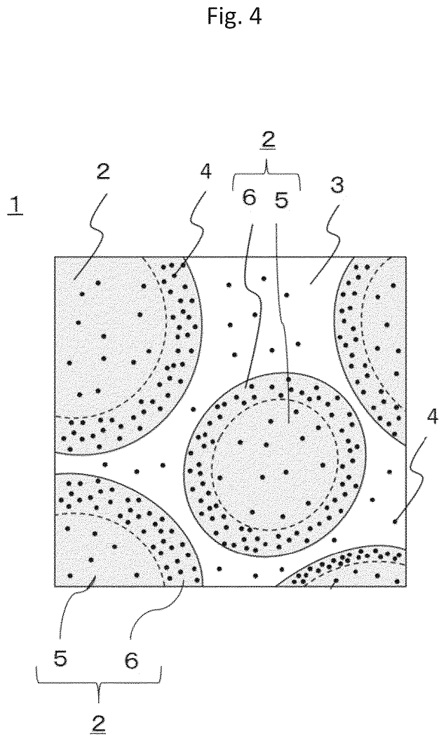

The Sm content is higher in the main phase 2 than in the grain boundary phase 3. Sm only needs to be present at a higher content on average in the main phase 2 than in the grain boundary phase 3. That is, the Sm content does not need to be uniformly high in the main phase 2 as shown in FIG. 1; for example, the Sm content in the main phase 2 may have a distribution as shown in FIG. 2 to FIG. 4. FIG. 2 to FIG. 4 are schematic diagrams of a part of the rare earth sintered magnet 1. In FIG. 2, the Sm content differs depending on regions of the main phase 2. In FIG. 3, the Sm content forms a core-shell structure in the main phase 2. The core-shell structure of the main phase 2 is a structure in which the Sm content is different between a core 5, which is the inner portion of a region of the main phase 2, and a shell 6, which is the outer peripheral portion of the core 5. In the rare earth sintered magnet 1 in FIG. 3, the Sm content is higher in the core 5 than in the shell 6. In FIG. 4, the Sm content forms the core-shell structure in a region of the main phase 2, and the Sm content is higher in the shell 6 than in the core 5. In the rare earth sintered magnet 1 shown in FIG. 1 to FIG. 4, Sm is present in the main phase 2 at a higher content on average than in the grain boundary phase 3.

According to the Encyclopedic Dictionary of Chemistry published by Tokyo Kagaku Doujin, the electrical resistivity of each element is as follows; Nd: 64 μΩ·cm (25 deg C.), Sm: 92 μΩ·cm (25 deg C.), La: 59 μΩ·cm (25 deg C.), Dy: 91 μΩ·cm (25 deg C.).

In the rare earth sintered magnet 1 according to the present embodiment, Sm, which has a higher electrical resistivity than Nd, is present in the main phase 2 at a higher content on average than in the grain boundary phase 3. This improves the electrical resistivity of the main phase 2, which is responsible for the magnetic flux generation, and reduces an eddy current loss. Therefore, heat generation in the rare earth sintered magnet 1 due to the eddy current loss can be suppressed. In the case where the Sm content in the main phase 2 is higher in the core 5 than in the shell 6 as in the rare earth sintered magnet 1 shown in FIG. 3, the Sm substitution at the Nd sites occurs more in the core 5 than in the shell 6. Therefore, contrary to the distribution of Sm, Nd is distributed more in the shell 6 than in the core 5 in the main phase 2. This results in a high content of Nd, which has higher magnetic anisotropy, in the shell 6. The enhanced magnetic anisotropy in the shell 6 of the main phase 2 suppresses magnetization reversal.

The grain boundary phase 3 is based on an oxide phase represented by (Nd, Sm)—O, which is formed by the Sm substitution at some of the Nd sites of a crystalline NdO phase. When the rare earth element R includes La, the crystalline grain boundary phase 3 is based on (Nd, La, Sm)—O, which is formed by substitution made by La and Sm at some of the Nd sites of the crystalline NdO phase. The content of La, which has a lower electrical resistivity than Nd, is higher in the grain boundary phase 3 than in the main phase 2. This prevents a decrease in the electrical resistivity of the main phase 2 due to the addition of La, which has a lower electrical resistivity. Experimental results also show that with the addition of La, Sm is present at a higher content in the main phase 2 than in the grain boundary phase 3. Therefore, heat generation in the rare earth sintered magnet 1 due to the eddy current loss can be suppressed.

The rare earth sintered magnet 1 according to Embodiment 1 may contain an additive element M that improves magnetic properties. The additive element M is at least one element selected from the group consisting of Al (aluminum), Cu (copper), Co, Zr (zirconium), Ti (titanium), Ga (gallium), Pr (praseodymium), Nb (niobium), Dy, Tb (terbium), Mn (manganese), Gd, and Ho (holmium).

When the total of the elements contained in the rare earth sintered magnet 1 according to Embodiment 1 is 100 at % and the content ratios of Nd, La, Sm, Fe, B, and the additive element M are a, b, c, d, e, and f, respectively, the following relational expressions are desirably satisfied.

5≤a≤20

0<b+c<a

70≤d≤590

0.5≤e≤10

0≤f≤5

a+b+c+d+e+f=100 at %

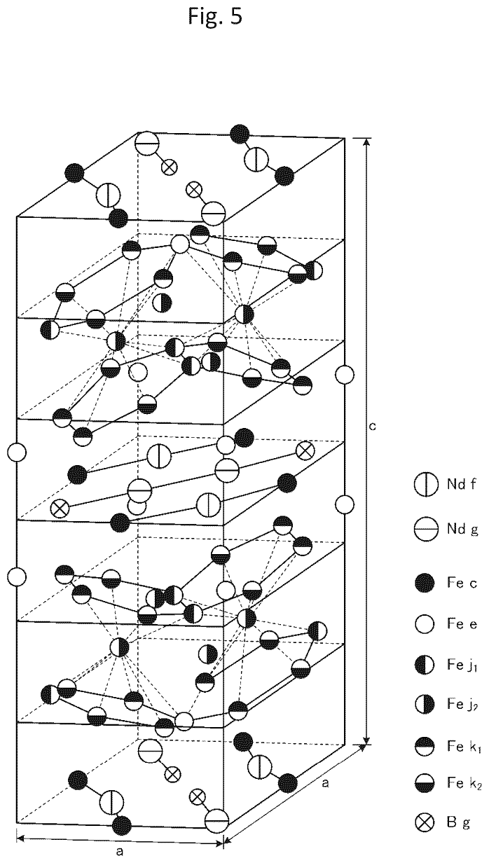

Next, it is described at which atomic sites of the tetragonal R₂Fe₁₄B crystal structure La and Sm make substitution. FIG. 5 is a diagram showing atomic sites in a tetragonal Nd₂Fe₁₄B crystal structure (source: J. F. Herbst et al., PHYSICAL REVIEW B, Vol. 29, No. 7, pp. 4176-4178, 1984). The site where the substitution is made was determined by the numerical value of the stabilization energy due to substitution obtained by band calculation and molecular field approximation of the Heisenberg model.

A method of calculating the stabilization energy of La is described. The stabilization energy of La can be determined from the energy difference between (Nd₇Lai)Fe₅₆B4+Nd and Nd₈(Fe₅₅La₁)B₄+Fe using a Nd₈Fe₅₆B₄ crystal cell. The smaller the value of energy, the more stable it is when an atom is substituted at that site. That is, La is likely to make substitution at an atomic site having the smallest energy among the atomic sites. This calculation assumes that, when the original atom is substituted with La, the difference in atomic radius does not change the lattice constant of the tetragonal R₂Fe₁₄B crystal structure. Table 1 shows the stabilization energies of La at each substitution site at different environmental temperatures.

TABLE 1

| La | | | | | | |
|---|---|---|---|---|---|---|
| substitution | Temperature | | | | | |
| site | 293K | 500K | 1000K | 1300K | 1400K | 1500K |
| Nd(F) | −136.372 | −84.943 | −48.524 | −40.132 | −38.132 | −35.451 |
| Nd(g) | −132.613 | −82.740 | −47.442 | −38.211 | −36.358 | −34.753 |
| Fe(k1) | −135.939 | −80.596 | −41.428 | −32.390 | −30.237 | −17.095 |
| Fe(k2) | −127.480 | −75.638 | −38.948 | −30.482 | −28.466 | −26.719 |
| Fe(j1) | −124.248 | −73.076 | −38.003 | −29.754 | −27.791 | −26.089 |
| Fe(j2) | −117.148 | −71.400 | −35.923 | −28.816 | −26.917 | −25.271 |
| Fe(e) | −130.814 | −77.593 | −39.926 | −31.235 | −29.164 | −27.371 |
| Fe(c) | −148.317 | −87.850 | −45.055 | −35.179 | −32.828 | −30.789 |

Unit: eV

Table 1 shows that a stable La substitution site for temperatures of 1000 K or higher is the Nd(f) site. It is considered that the La substitution is made preferentially at the Nd (f) site, which is energetically stable; however, the substitution may also be made at the Nd (g) site, which has a small energy difference from the Nd (f) site among the La substitution sites. The Fe(c) site is a stable substitution site at 293 K and 500 K. As described below, a method of manufacturing the rare earth sintered magnet 1 includes sintering of a raw alloy at a temperature of 1000 K or higher in a sintering process 24. Then, the magnet is produced through a cooling process 25 that holds the temperature between 500 K and 700 K for a certain period of time. Therefore, in the sintering process, the substitution is made at the Nd (f) site, which is the most stable substitution site, or at the Nd (g) site, which has a small energy difference from the Nd (f) site. After that, the site of La substitution is considered to be changed from the Nd (f) site or the Nd (g) site to the Fe (c) site in the cooling process.

A method of calculating the stabilization energy of Sm is described. The stabilization energy of Sm can be determined from the energy difference between (Nd₇Sm₁)Fe₅₆B₄+Nd and Nds(Fe₅₅Sm₁)B₄+Fe. Similar to the case of La, it is assumed that the substitution of atoms does not change the lattice constant of the tetragonal R₂Fe₁₄B crystal structure. Table 2 shows the stabilization energies of Sm at each substitution site at different environmental temperatures.

TABLE 2

| Sm | | | | | | |
|---|---|---|---|---|---|---|
| substitution | Temperature | | | | | |
| site | 293K | 500K | 1000K | 1300K | 1400K | 1500K |
| Nd(f) | −164.960 | −101.695 | −56.921 | −46.589 | −44.128 | −41.976 |
| Nd(g) | −168.180 | −103.583 | −57.865 | −47.315 | −44.803 | −42.626 |
| Fe(k1) | −136.797 | −81.098 | −41.679 | −32.583 | −17.350 | −16.343 |
| Fe(k2) | −127.769 | −75.808 | −38.482 | −29.603 | −28.528 | −25.696 |
| Fe(j1) | −122.726 | −73.304 | −37.783 | −28.392 | −26.525 | −24.681 |
| Fe(j2) | −124.483 | −73.883 | −38.072 | −28.483 | −26.610 | −24.985 |
| Fe(e) | 125.937 | 72.525 | 35.301 | 26.633 | 24.450 | 22.782 |
| Fe(c) | −155.804 | −94.457 | −48.359 | −37.720 | −35.187 | −32.992 |

Unit: eV

Table 2 shows that a stable substitution site for Sm is the Nd(g) site at any temperature. It is considered that substitution is made preferentially at the Nd (g) site, which is energetically stable; however, the substitution may also be made at the Nd (f) site, which has a small energy difference from the Nd (g) site among the Sm substitution sites.

Further, a comparison between Table 1 and Table 2 shows that, in the rare earth sintered magnet 1 manufactured by the manufacturing method described below, the calculated stabilization energy of the Nd site is smaller and more stable for Sm than for La. In other words, the substitution at the Nd site in the Nd₂Fe₁₄B crystal structure of the main phase 2 is more likely to be made by Sm than by La. Therefore, in the main phase 2, Sm is present at a high content, and La is present at a low content.

As described above, the rare earth sintered magnet 1 according to the present embodiment includes the main phase 2 and the grain boundary phase 3; the main phase 2 has an R₂Fe₁₄B crystal structure containing at least Nd and Sm as rare earth elements R; the content of Sm, which has a higher electrical resistivity than Nd, is higher in the main phase 2 than in the grain boundary phase 3. This improves the electrical resistivity of the main phase 2, which is responsible for the magnetic flux generation, and suppresses heat generation of the rare earth sintered magnet 1 due to the eddy current loss. The Sm present in the main phase 2 couples in the same magnetization direction as the ferromagnetic Fe and contributes to the improvement of the residual magnetic flux density.

La may be contained as a rare earth element R and may be present at a higher content in the grain boundary phase 3 than in the main phase 2. La, which has a lower electrical resistivity than Nd, is present at a higher content in the grain boundary phase 3 than in the main phase 2. This prevents a decrease in the electrical resistivity of the main phase 2 and suppresses heat generation of the rare earth sintered magnet 1 due to the eddy current loss.

In the cooling process 25, the site of La substitution changes from the Nd site, which is a stable substitution site in the sintering process 24, to the Fe(c) site. The stable site of Sm substitution is the Nd site at any temperature in the sintering process 24 and the cooling process 25. Therefore, the inclusion of La promotes the Sm substitution at the Nd site where the La substitution has been made in the sintering process 24. This allows Sm to be present at a higher content in the main phase 2, thereby suppressing the heat generation of the rare earth sintered magnet 1 due to the eddy current loss.

The rare earth sintered magnet 1 includes the crystalline grain boundary phase 3 based on an oxide phase represented by (Nd, Sm)—O, which is formed by the Sm substitution at some of the Nd sites of the crystalline NdO phase. Thus, the presence of Sm, which is a rare earth element R like Nd, in the grain boundary phase 3 allows Nd to relatively diffuse into the main phase 2. This prevents the Nd in the main phase 2 from being consumed in the grain boundary phase 3, and thus the magnetic anisotropy constant and a saturated magnetic polarization are improved, enhancing the magnetic properties.

When La is contained as a rare earth element R, the grain boundary phase 3 is a crystalline phase represented by (Nd, La, Sm)—O. Similar to Sm, the presence of La in the grain boundary phase 3 allows Nd to relatively diffuse into the main phase 2. This prevents Nd in the main phase 2 from being consumed in the grain boundary phase 3, and thus the magnetic anisotropy constant and the saturated magnetic polarization are improved, enhancing the magnetic properties.

Sm may be added to a magnet containing Dy, which has a higher electrical resistivity than Nd. The addition of Sm reduces the eddy current loss with a smaller amount of Dy than usual. This can reduce the use of Dy, which is unstable in supply due to its uneven distribution and limited production. La should be added to achieve a well-balanced morphology of the magnet internal structure that enables both the suppression of eddy current loss by increasing the electrical resistivity of the main phase 2 and the magnetic properties with temperature rise.

An excessive Sm content may lead to a relative decrease in the content of Nd, which is an element having a high magnetic anisotropy constant and a high saturated magnetic polarization, and degradation of the magnetic properties. Therefore, in the rare earth sintered magnet 1, the composition ratio of Nd should be larger than that of Sm. When La is contained as a rare earth element R, the composition ratio of Nd should be larger than the sum of the composition ratio of La and that of Sm. In other words, when rare earth elements R other than Nd are included, the total amount of the rare earth elements R other than Nd should be less than the amount of Nd.

### Embodiment 2

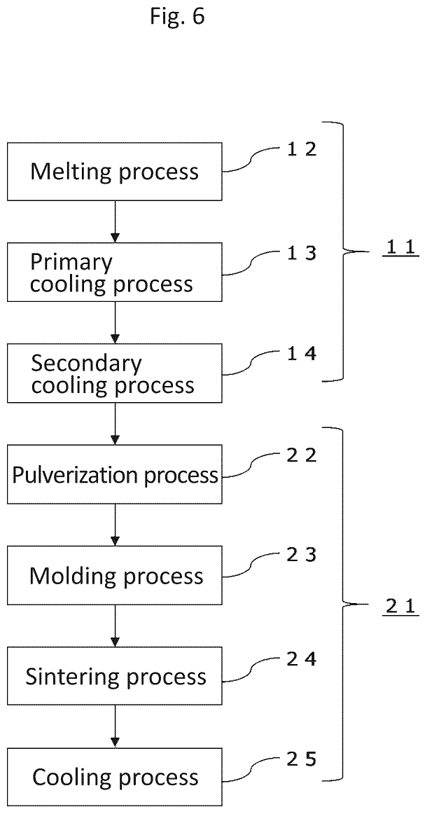

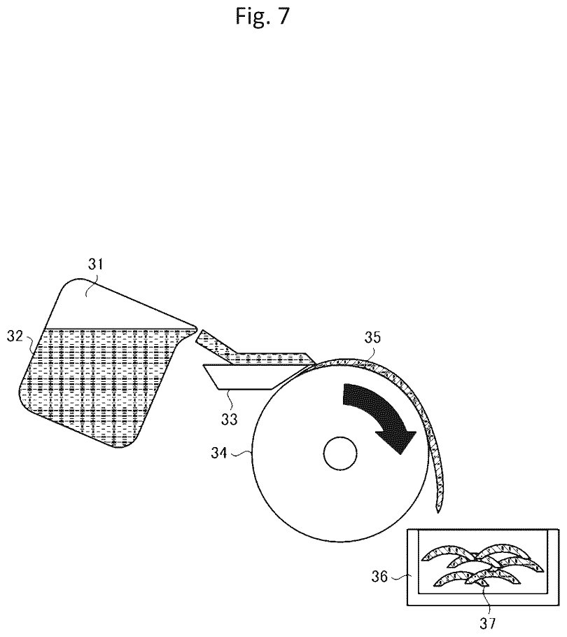

The present embodiment relates to a method of manufacturing the rare earth sintered magnet 1 according to Embodiment 1. The description thereof is made with reference to FIG. 6 and FIG. 7. FIG. 6 is a flowchart showing a procedure of the method of manufacturing the rare earth sintered magnet 1 according to the present embodiment. FIG. 7 is a schematic diagram showing an operation of a raw alloy production process 11. Hereinafter, the raw alloy production process 11 and a sintered magnet production process 21 are described separately.

### [Raw Alloy Production Process 11]

As shown in FIG. 6 and FIG. 7, the raw alloy production process 11 includes: a melting process 12 in which a raw material of a rare earth magnet alloy 37 is heated to a temperature of 1000 K or higher and melted; a primary cooling process 13 in which the raw material in a molten state is cooled on a rotator 34 to produce a solidified alloy 35; and a secondary cooling process 14 in which the solidified alloy 35 is further cooled in a tray 36.

In the melting process 12, the raw material of the rare earth magnet alloy 37 is melted to produce a molten alloy 32. The raw material contains Nd, Fe, B, and Sm. Other rare earth elements R may be contained, and preferably La is contained. As additive elements, one or more elements selected from Al, Cu, Co, Zr, Ti, Ga, Pr, Nb, Mn, Gd, and Ho may be contained. As exemplified in FIG. 7, in an atmosphere containing an inert gas such as Ar or in a vacuum, the raw material of the rare earth magnet alloy 37 is heated to a temperature of 1000 K or higher in a crucible 31 and melted to produce the molten alloy 32.

In the primary cooling process 13, as exemplified in FIG. 7, the molten alloy 32 is poured into a tundish 33 and is rapidly cooled on the rotator 34, so that the solidified alloy 35 thinner than an ingot alloy is produced from the molten alloy 32. In FIG. 7, a single roll is exemplified as the rotator 34; however, twin rolls, a rotary disk, a rotary cast cylinder, etc. may be used for rapid cooling by making contact therewith. For efficient production of the thin solidified alloy 35, the cooling rate in the primary cooling process 13 should be 10 to 107 deg C./sec, preferably 103 to 104 deg C./sec. The thickness of the solidified alloy 35 is between 0.03 mm and 10 mm. The molten alloy 32 solidifies from the point where it contacts the rotator 34, and crystals grow in a columnar or needle-like shape in the direction of thickness from the surface of contact with the rotator 34.

In the secondary cooling process 14, the solidified alloy 35 is cooled in the tray 36 as exemplified in FIG. 7. When entering the tray 36, the thin solidified alloy 35 is broken into scale-like pieces of the rare earth magnet alloy 37 and cooled. Although the scale-like pieces of the rare earth magnet alloy 37 are exemplified, ribbon-like pieces of the rare earth magnet alloy 37 are produced depending on the cooling rate. For producing the rare earth magnet alloy 37 with the optimum rare earth magnet alloy 37 internal structure, the cooling rate in the secondary cooling process 14 should be 0.01 to 105 deg C./sec, preferably 0.1 to 10² deg C./sec.

Through the above-described raw alloy production process 11, the R—Fe—B system rare earth magnet alloy 37 containing at least Nd and Sm as rare earth elements R is produced.

### [Sintered Magnet Production Process 21]

As shown in FIG. 6, the sintered magnet production process 21 includes: a pulverization process 22 in which the rare earth magnet alloy 37 produced in the above-described raw alloy production process 11 is pulverized; a molding process 23 in which the pulverized rare earth magnet alloy 37 is molded to produce a compact; the sintering process 24 in which the compact is sintered to produce a sintered compact; and the cooling process 25 in which the sintered compact is cooled. The sintered magnet production process 21 is not limited to this but may be performed, for example, by hot working, in which the molding process 23 and the sintering process 24 are performed at the same time.

The pulverization process 22 is to pulverize the R—Fe—B system rare earth magnet alloy 37, which contains Nd and Sm as rare earth elements R and is produced in the above-mentioned raw alloy production process 11, and to produce a powder with a grain diameter of no more than 200 μm, preferably between 0.5 μm and 100 μm. The rare earth magnet alloy 37 is pulverized by using, for example, an agate mortar, a stamp mill, a jaw crusher, a jet mill, or the like. To obtain a powder with a small particle diameter, the pulverization process 22 should be performed in an atmosphere containing inert gas. The pulverization of the rare earth magnet alloy 37 in an atmosphere containing inert gas can also prevent oxygen from entering the powder. If the atmosphere in which the pulverization is performed does not affect the magnetic properties of the magnet, the pulverization of the rare earth magnet alloy 37 may be performed in the air.

In the molding process 23, the powder of the rare earth magnet alloy 37 is molded to produce a compact. For example, in the molding, only the powder of the rare earth magnet alloy 37 may be press-molded, or a mixture of the powder of the rare earth magnet alloy 37 and an organic binder may be press-molded. The molding may be performed while applying a magnetic field. The magnetic field to be applied is 2 T, for example.

In the sintering process 24, the compact is heat-treated to produce a sintered compact. The sintering is performed at a temperature between 600 deg C. and 1300 deg C., for 0.1 hours to 10 hours. The sintering should be performed in an atmosphere containing inert gas or in a vacuum to suppress oxidation. The sintering may be performed while applying a magnetic field. A process may be added to allow compounds containing Cu, Al, heavy rare earth elements, etc. to permeate the crystal grain boundary, which is the boundary between the regions of the main phase 2.

In the cooling process 25, the sintered compact sintered between 600 deg C. and 1300 deg C. is cooled. In the cooling process, the sintered compact is held at a temperature between 227 deg C. and 427 deg C. (500 K and 700 K) for 0.1 hours to 5 hours. The sintered compact is then cooled to room temperature to complete the rare earth sintered magnet 1.

By controlling the temperatures and times of the sintering process 24 and cooling process 25 described above, the magnet internal structure based on the calculated stabilization energy described in Embodiment 1 can be produced. In other words, this enables the production of the rare earth sintered magnet 1 in which Sm is present at a higher content in the main phase 2 than in the grain boundary phase 3. The grain boundary phase 3 has the (Nd, Sm)—O phase formed by the Sm substitution in the crystalline NdO phase. This improves the electrical resistivity of the main phase 2, which is responsible for the magnetic flux generation, and suppresses heat generation of the rare earth sintered magnet 1 due to the eddy current loss.

It is preferable to add La to the raw material of the rare earth magnet alloy 37. By adding La and controlling the temperatures and times of the sintering process 24 and the cooling process 25, Sm can be more stably present in the main phase 2. La is present at a higher content in the grain boundary phase 3 than in the main phase 2, but is also partially present in the main phase 2. Table 1 shows that the stable La substitution site is the Nd(f) site at a temperature of 1000 K or higher, and is the Fe(c) site at a temperature of 500 K or lower. In addition, experiments show that the La substitution is likely to change from the Nd(f) site to the Fe(c) site at a temperature between 500 K and 700 K. In contrast, table 2 shows that the stable substitution site for Sm is the Nd(g) site at any temperature. It is considered that the substitution is made preferentially at the Nd (g) site, which is energetically stable; however, the substitution may also be made at the Nd (f) site, which has a small energy difference from the Nd (g) site among the Sm substitution sites. These findings indicate that the La substitution site in the main phase 2 changes from the Nd(f) site to the Fe(c) site through the cooling process that holds the temperature between 227 deg C. and 427 deg C. (500 K and 700 K) for a certain period of time. This promotes, in the cooling process 25, the Sm substitution at the Nd site where the La substitution has been made in the sintering process 24, and allows the Sm content to be higher in the main phase 2. Therefore, by controlling the temperatures and times of the sintering process 24 and cooling process 25, the rare earth sintered magnet 1 can be produced in which the main phase 2 has the (Nd, La, Sm)₂Fe₁₄B crystal structure and the Sm content is higher in the main phase 2 than in the grain boundary phase 3. The grain boundary phase 3 has the (Nd, La, Sm)—O phase formed by the substitution made by La and Sm in the crystalline NdO phase.

### Embodiment 3

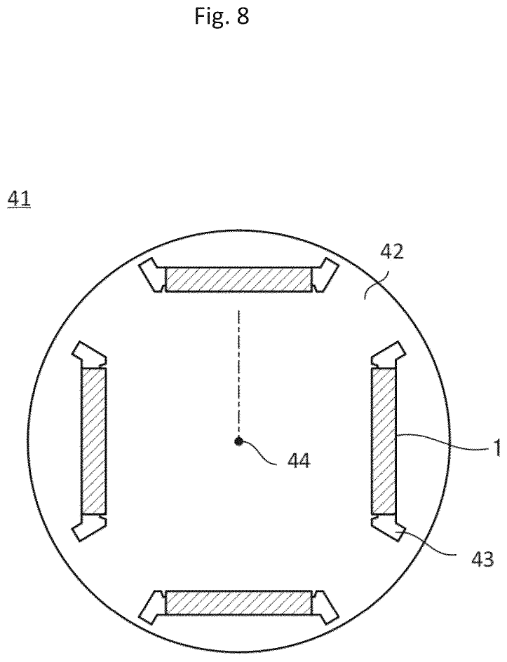

The present embodiment relates to a rotor 41 that includes the rare earth sintered magnet 1 according to Embodiment 1. The rotor 41 according to the present embodiment is described with reference to FIG. 8. FIG. 8 is a schematic cross-sectional view perpendicular to an axial direction of the rotor 41.

The rotor 41 is rotatable about an axis of rotation 44. The rotor 41 includes a rotor core 42 and a plurality of the rare earth sintered magnets 1 inserted into magnet insertion holes 43 provided in the rotor core 42 along a circumferential direction of the rotor 41. FIG. 8 shows an example including four magnet insertion holes 43 and four rare earth sintered magnets 1; however, the number of magnet insertion holes 43 and the number of rare earth sintered magnets 1 may be changed according to the design of the rotor 41. The rotor core 42 is formed of a plurality of disk-shaped electromagnetic steel plates stacked in the axial direction of the axis of rotation 44.

The rare earth sintered magnets 1 are manufactured according to the manufacturing method of Embodiment 2. The four rare earth sintered magnets 1 are inserted into their respective magnet insertion holes 43. The four rare earth sintered magnets 1 are magnetized in such a way that, on the radially outer side of the rotor 41, each of the rare earth sintered magnets 1 has a polarity different from that of the adjacent rare earth sintered magnets 1.

A general rotor 41 becomes unstable in operation when the coercive forces of the rare earth sintered magnets 1 decrease in a high-temperature environment. The rotor 41 in the present embodiment includes the rare earth sintered magnets 1 manufactured according to the manufacturing method described in Embodiment 2. With the rare earth sintered magnets 1, the heat generation thereof due to the eddy current loss can be suppressed. In addition, absolute values of temperature coefficients of magnetic properties are small, as described later in the examples. This suppresses the heat generation of the rare earth sintered magnets 1 and suppresses the deterioration of the magnetic properties even in a high-temperature environment such as 100 deg C. or higher, thereby stabilizing the operation of the rotor 41.

### Embodiment 4

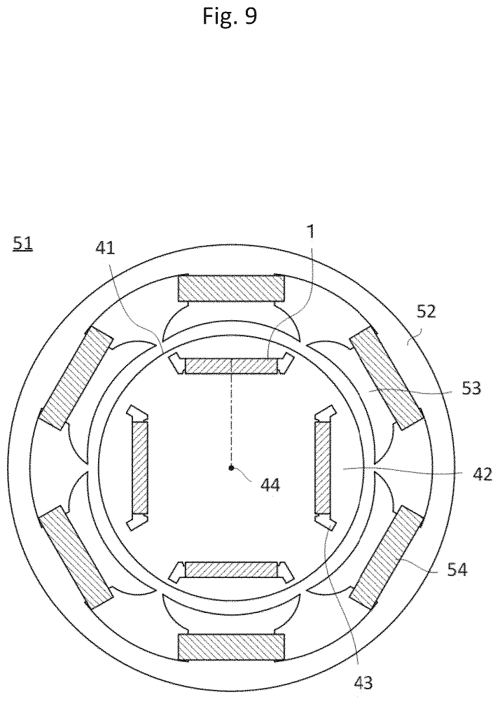

The present embodiment relates to a rotating machine 51 provided with the rotor 41 according to Embodiment 3. The rotating machine 51 according to the present embodiment is described with reference to FIG. 9. FIG. 9 is a schematic cross-sectional view perpendicular to an axial direction of the rotating machine 51.

The rotating machine 51 includes the rotor 41 according to Embodiment 3 and an annular stator 52 provided coaxially with the rotor 41 and disposed facing the rotor 41. The stator 52 is formed of a plurality of electromagnetic steel plates stacked in the axial direction of the axis of rotation 44. The configuration of the stator 52 is not limited to this, and existing configurations may be employed. The stator 52 includes teeth 53 protruding toward the rotor 41 along an inner surface of the stator 52. The teeth 53 are provided with windings 54. The windings 54 may be wound in a concentrated manner or distributed manner, for example. The number of magnetic poles of the rotor 41 in the rotating machine 51 should be two or more; in other words, the number of rare earth sintered magnets 1 should be two or more. FIG. 9 shows an example of a magnet-embedded type rotor 41; however, a surface-magnet type rotor 41 having rare earth magnets fixed to the periphery with adhesive can also be used.

The general rotating machine 51 becomes unstable in operation when the coercive forces of the rare earth sintered magnets 1 decrease in a high-temperature environment. The rotor 41 in the present embodiment includes the rare earth sintered magnets 1 manufactured according to the manufacturing method described in Embodiment 2. With the rare earth sintered magnets 1, the heat generation thereof due to the eddy current loss can be suppressed. In addition, the absolute values of the temperature coefficients of magnetic properties are small, as described later in the examples. This suppresses the heat generation of the rare earth sintered magnets 1 and suppresses the deterioration of the magnetic properties even in a high-temperature environment such as 100 deg C. or higher, thereby driving the rotor 41 stably and stabilizing the operation of the rotating machine 51.

The configurations shown in the above-described embodiments are examples and can be combined with another known technique. It is also possible to combine the embodiments, and to omit or change a part of the configuration to the extent that it does not depart from the gist.

### EXAMPLES

Evaluation results of the magnetic properties and eddy current losses of the rare earth sintered magnets 1 produced by the manufacturing method of Embodiment 2 are described with reference to Table 3. Table 3 is a summary of determination results of the magnetic properties and eddy current losses of Examples 1 to 7 and Comparative Examples 1 to 4, which are samples of the rare earth sintered magnets 1 having different contents of Nd, La, and Sm.

TABLE 3
Determination results of magnetic properties and eddy current losses of rare earth sintered magnets 1

| | | | | | | Determination | | |
|---|---|---|---|---|---|---|---|---|
| | | | | | | Temperature | Temperature | |
| | | | | | | coefficient (\|α\|) of | coefficient | |
| | | Content (at %) | | | | residual magnetic | (\|β\|) of | Eddy |
| | General formula | Nd | La | Sm | Dy | flux density | coercive force | current loss |
| Comparative | Nd-Fe-B | 11.23 | — | — | — | — | — | — |
| Example 1 | | | | | | | | |
| Comparative | (Nd, Dy)-Fe-B | 10.01 | — | — | 1.12 | Equivalent | Equivalent | Good |
| Example 2 | | | | | | | | |
| Comparative | (Nd, La)-Fe-B | 10.98 | 0.31 | — | — | Poor | Poor | Equivalent |
| Example 3 | | | | | | | | |
| Comparative | (Nd, La)-Fe-B | 10.22 | 1.01 | — | — | Poor | Poor | Equivalent |
| Example 4 | | | | | | | | |
| Example 1 | (Nd, Sm)-Fe-B | 11.02 | — | 0.29 | — | Poor | Poor | Good |
| Example 2 | (Nd, Sm)-Fe-B | 10.22 | — | 1.01 | — | Poor | Poor | Good |
| Example 3 | (Nd, La, Sm)-Fe-B | 10.97 | 0.09 | 0.07 | — | Good | Good | Good |
| Example 4 | (Nd, La, Sm)-Fe-B | 10.73 | 0.09 | 0.07 | — | Good | Good | Good |
| Example 5 | (Nd, La, Sm)-Fe-B | 10.27 | 0.51 | 0.45 | — | Good | Good | Good |
| Example 6 | (Nd, La, Sm)-Fe-B | 10.55 | 0.35 | 0.33 | — | Good | Good | Good |
| Example 7 | (Nd, La, Sm)-Fe-B | 8.41 | 1.01 | 1.01 | — | Good | Good | Good |

The magnetic properties are determined by measuring the residual magnetic flux density and coercive force of each sample using a pulse excitation type B-H curve tracer. The maximum applied magnetic field by the B-H curve tracer is 6 T or higher, at which the sample is completely magnetized. Instead of the pulse excitation type B-H curve tracer, a DC recording magnetic flux meter, which is called a direct current type B-H curve tracer, a vibrating sample magnetometer (VSM), a magnetic property measurement system (MPMS), a physical property measurement system (PPMS), etc. may be used if they can generate a maximum applied magnetic field of 6 T or more. The measurements were performed in an atmosphere containing an inert gas such as nitrogen, and evaluation was performed at room temperature. The magnetic properties of each sample were measured at a first measurement temperature T1 and a second measurement temperature T2 which are different from each other. A temperature coefficient α [%/deg C] of the residual magnetic flux density is a value obtained by calculating a ratio of a difference between the residual magnetic flux density at the first measurement temperature T1 and the residual magnetic flux density at the second measurement temperature T2 to the residual magnetic flux density at the first measurement temperature T1 and by dividing the ratio by a temperature difference (T2−T1). A temperature coefficient β [%/deg C] of the coercive force is a value obtained by calculating a ratio of a difference between the coercive force at the first measurement temperature T1 and the coercive force at the second measurement temperature T2 to the coercive force at the first measurement temperature T1 and by dividing the ratio by the temperature difference (T2−T1). Therefore, the smaller the absolute values of the temperature coefficients |α| and |β| of the magnetic properties, the more the deterioration of the magnetic properties of the magnet due to temperature rise is suppressed.

The measurement conditions of the present example are described. Each sample has a cube shape, and its length, width, and height are all 7 mm. In the measurements of the temperature coefficient α of the residual magnetic flux density and the temperature coefficient β of the coercive force, the first measurement temperature T1 is 23 deg C. and the second measurement temperature T2 is 200 deg C. Here, 23 deg C. is room temperature, and 200 deg C. is a possible operating environment temperature for automotive and industrial motors.

The temperature coefficient of the residual magnetic flux density and the temperature coefficient of the coercive force of samples of Examples 1 to 7 and Comparative Examples 2 to 4 were determined in comparison with Comparative Example 1. Table 3 shows the results of the comparison between the sample of Comparative Example 1 and each of the other samples with respect to the absolute value of the temperature coefficient |α| of the residual magnetic flux density and the absolute value of the temperature coefficient |β| of the coercive force; when the value is within ±1%, which is considered to be a measurement error, the determination is “Equivalent”; when the value is −1% or less, the determination is “Good”; when the value is 1% or more, the determination is “Poor”.

The eddy current loss is determined using, for example, a DC magnetic property test apparatus (magnetic flux integrator type) or an AC magnetic property test apparatus (power meter method). The DC and AC magnetic properties of each sample were evaluated by sandwiching the rare earth sintered magnet 1 between C-shaped yokes, exciting the sample by AC with a primary winding inside the coil frame, and detecting the induced voltage with a secondary winding. In the present example, the number of turns of the primary winding was 200 and the number of turns of the secondary winding was 100, but the number of turns may be changed depending on the sample to be measured. In the present example, measurements were performed at frequencies of 1 kHz, 2 kHz, and 3 kHz under the measurement conditions of magnetic flux densities of 0.01 T and 0.1 T using the AC magnetic property. The eddy current loss was calculated by subtracting the hysteresis loss from the obtained total iron loss. The higher the electrical resistivity of the main phase 2 of the rare earth sintered magnet 1 being evaluated, the smaller the eddy current loss. The smaller the eddy current loss is, the less heat is generated by the eddy current loss in the sintered rare earth magnet 1, which means that it is a rare earth sintered magnet 1 with suppressed heat generation.

The eddy current losses in samples of Examples 1 to 7 and Comparative Examples 2 to 4 were determined in comparison with Comparative Example 1. Table 3 shows the results of the measurement at a residual magnetic flux density of 0.01 T and a frequency of 3 kHz. When the value is within +3%, which is considered to be a measurement error, the determination is “Equivalent”; when the value is −3% or less, the determination is “Good”; when the value is 3% or more, the determination is “Poor”.

Comparative Example 1 is a sample produced according to the manufacturing method of Embodiment 2 using Nd, Fe, and B as raw materials of the rare earth magnet alloy 37 so that the general formula will be Nd—Fe—B. The magnetic properties and eddy current loss of this sample were determined by the above-mentioned method. The temperature coefficient |α| of the residual magnetic flux density was 0.191%/deg C, and the temperature coefficient |β| of the coercive force was 0.460%/deg C. The eddy current loss was 2.98 W/kg. These values of Comparative Example 1 were used as references.

Comparative Example 2 is a sample produced according to the manufacturing method of Embodiment 2 using Nd, Dy, Fe, and B as the raw materials of the rare earth magnet alloy 37 so that the general formula will be (Nd, Dy)—Fe—B. The magnetic properties and eddy current loss of this sample were determined by the method described above; the temperature coefficient of residual magnetic flux density was “Equivalent”, the temperature property of coercive force was “Equivalent”, and the eddy current loss was “Good”. This determination result indicates that substitution made by Dy, which has a higher electrical resistivity than Nd, at some of the Nd sites of the main phase 2 increased the electrical resistivity of the main phase 2 and reduced the eddy current loss.

Comparative Example 3 and Comparative Example 4 are samples produced according to the manufacturing method of Embodiment 2 using Nd, La, Fe, and B as the raw materials of the rare earth magnet alloy 37 so that the general formula will be (Nd, La)—Fe—B. The La contents (at %) in Comparative Example 3 and Comparative Example 4 are 0.31 and 1.01, respectively. The magnetic properties and eddy current losses of these samples were each determined by the method described above; the temperature coefficient of residual magnetic flux density was “Poor”, the temperature property of coercive force was “Poor”, and the eddy current loss was “Equivalent”. This result indicates that the addition of only La to Nd—Fe—B does not contribute to the improvement of the magnetic properties. Comparative Example 3 and Comparative Example 4 show that eddy current loss is “Equivalent” even when the content of La, which has lower electrical resistivity than Nd, is increased. This means that because the La content was higher in the grain boundary phase 3 than in the main phase 2, the reduction of the electrical resistivity of the main phase 2, which is responsible for the magnetic flux generation, was suppressed.

Example 1 and Example 2 are samples produced according to the manufacturing method of Embodiment 2 using Nd, Sm, Fe, and B as the raw materials of the rare earth magnet alloy 37 so that the general formula will be (Nd, Sm)—Fe—B. The Sm content (at %) in Example 1 and Example 2 are 0.29 and 1.01, respectively. The magnetic properties and eddy current losses of these samples were each determined by the method described above; the temperature coefficient of residual magnetic flux density was “Poor”, the temperature property of coercive force was “Poor”, and the eddy current loss was “Good”.

The samples of Example 1 and Example 2 are the rare earth sintered magnets 1 in which the main phase 2 has the R₂Fe₁₄B crystal structure containing at least Nd and Sm as the rare earth elements R, and the main phase 2 contains Sm at a higher content than the grain boundary phase 3. Thus, the substitution made by Sm, which has a high electrical resistivity, at some of the Nd sites of the main phase 2 increases the electrical resistivity of the main phase 2 and reduces the eddy current loss. It was also found that the addition of only Sm to Nd—Fe—B does not contribute to the improvement of the magnetic properties.

Examples 3 to 7 are samples produced according to the manufacturing method of Embodiment 2 using Nd, La, Sm, Fe, and B as the raw materials of the rare earth magnet alloy 37 so that the general formula will be (Nd, La, Sm)—Fe—B. The magnetic properties and eddy current losses of these samples were each determined by the method described above; the temperature coefficient of residual magnetic flux density was “Good”, the temperature property evaluation of coercive force was “Good”, and the eddy current loss was “Good”.

The samples of Examples 3 to 7 have an R₂Fe₁₄B crystal structure in which the main phase 2 contains at least Nd, La, and Sm as the rare earth elements R. In the rare earth sintered magnet 1, the content of Sm is higher in the main phase 2 than in the grain boundary phase 3, and the content of La is higher in the grain boundary phase 3 than in the main phase 2. In the cooling process 25, the inclusion of La promotes the Sm substitution at the Nd site where the La substitution has been made in the sintering process 24. This allows Sm to be present at a higher content in the main phase 2, thereby suppressing the heat generation of the rare earth sintered magnet 1 due to the eddy current loss.

The rare earth sintered magnet 1 includes the grain boundary phase 3 based on the oxide phase represented by (Nd, La, Sm)—O, which is formed by the substitution made by La and Sm at some of the Nd sites of the crystalline NdO phase. Thus, the presence of La and Sm in the grain boundary phase 3 allows Nd to relatively diffuse into the main phase 2. This prevents Nd in the main phase 2 from being consumed in the grain boundary phase 3, and thus the magnetic anisotropy constant and the saturated magnetic polarization are improved, enhancing the magnetic properties.

This also enables replacement of Nd and Dy, which are expensive, regionally uneven, and risky in procurement, with inexpensive La and Sm. Furthermore, the examples show that the rare earth sintered magnet 1 of the present disclosure prevents heat generation due to the eddy current loss while suppressing the decrease in magnetic properties as the temperature rises.

### REFERENCE SIGNS LIST

1 rare earth sintered magnet
2 main phase
3 grain boundary phase
4 Sm element
5 core
6 shell
11 raw alloy production process
12 melting process
13 primary cooling process
14 secondary cooling process
21 sintered magnet production process
22 pulverization process
23 molding process 23
24 sintering process
25 cooling process
31 crucible
32 molten alloy
33 tundish
34 rotator
35 solidified alloy
36 tray
37 rare earth magnet alloy
41 rotor
42 rotor core
43 magnet insertion hole
44 axis of rotation
51 rotating machine
52 stator
53 teeth
54 winding

1.-9. (canceled)

10. A rare earth sintered magnet comprising a main phase and a grain boundary phase, wherein
the main phase has an R₂Fe₁₄B crystal structure,
rare earth elements R include at least Nd and Sm, and
a content of the Sm is higher in the main phase than in the grain boundary phase.

11. The rare earth sintered magnet according to claim 10, wherein the rare earth elements R further include La, and a content of the La is higher in the grain boundary phase than in the main phase.

12. The rare earth sintered magnet according to claim 10, wherein the grain boundary phase has an (Nd, Sm)—O phase formed by substitution made by the Sm in a crystalline NdO phase.

13. The rare earth sintered magnet according to claim 10, wherein a composition ratio of the Nd is larger than that of the Sm.

14. The rare earth sintered magnet according to claim 11, wherein a composition ratio of the Nd is larger than that of the Sm.

15. The rare earth sintered magnet according to claim 12, wherein a composition ratio of the Nd is larger than that of the Sm.

16. The rare earth sintered magnet according to claim 11, wherein the grain boundary phase has an (Nd, La, Sm)—O phase formed by substitution made by the La and the Sm in a crystalline NdO phase.

17. The rare earth sintered magnet according to claim 11, wherein a composition ratio of the Nd is larger than a sum of a composition ratio of the La and that of the Sm.

18. The rare earth sintered magnet according to claim 16, wherein a composition ratio of the Nd is larger than a sum of a composition ratio of the La and that of the Sm.

19. A method of producing a rare earth sintered magnet comprising:
a pulverization process of pulverizing an R—Fe—B system rare earth magnet alloy containing at least Nd and Sm as rare earth elements R;
a molding process of molding a powder of the R—Fe—B system rare earth magnet alloy to produce a compact;
a sintering process of sintering the compact between 600 deg C. and 1300 deg C, inclusive, to produce a sintered compact; and
a cooling process of holding the sintered compact at a temperature between 227 deg C. and 427 deg C, inclusive, for 0.1 hours to 5 hours.

20. A rotor comprising:
a rotor core; and
the rare earth sintered magnet according to claim 10 provided in the rotor core.

21. A rotating machine comprising:
the rotor according to claim 20; and
an annular stator having windings provided on teeth, the teeth being on an inner surface of a side where the rotor is disposed and protruding toward the rotor, the stator being disposed facing the rotor.
